(19) United States
(12) Patent Application Publication
(10) Pub. No.: US 2008/0127785 A1
(43) Pub. Date: Jun. 5, 2008

(54) HANDHELD TOOL WITH INDICATING MEMBER

(75) Inventor: ZHENG-HENG SUN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/760,802

(22) Filed: Jun. 11, 2007

(30) Foreign Application Priority Data
Dec. 5, 2006 (CN) 200610201213.6

(51) Int. Cl. B25B 23/16

(52) U.S. Cl. 81/468

(57) ABSTRACT

A handheld tool includes a handle to be held by a human hand, a head, which is engagable with a fastener, a shaft extending from an end of the handle terminating at the head, and an indicating member arranged on the tool. The indicating member indicates tightening or loosening of the fastener when the tool is operated to rotate the fastener. The indicating member is helpful for a user to make sure a direction of rotation required for retightening and loosening the fastener.

### BACKGROUND OF THE INVENTION

1. Field of the Invention

The present invention relates to handheld tools manually operated to tighten or loosen fasteners such as screws, nuts or bolts, and particularly to a screwdriver with an indicating member for indicating tightening or loosening of a fastener.

2. Description of Related Art

When a handheld tool such as a screwdriver is used, a user may be unsure which way to turn the handheld tool to tighten or loosen a fastener.

What is desired, therefore, is a handheld tool indicating tightening or loosening of a fastener.

### SUMMARY OF THE INVENTION

An exemplary handheld tool includes a handle to be held by a human hand, a head which is engagable with a fastener, a shaft extending from an end of the handle terminating at the head, and an indicating member arranged on the tool. The indicating member indicates tightening or loosening of the fastener when the tool is operated to rotate the fastener.

Other advantages and novel features will become more apparent from the following detailed description when taken in conjunction with the accompanying drawings, in which:

### BRIEF DESCRIPTION OF THE DRAWINGS

FIG. 1 is an elevational view of a screwdriver in accordance with a first preferred embodiment of the present invention; and

FIG. 2 is an elevational view of a screwdriver in accordance with a second preferred embodiment of the present invention.

### DETAILED DESCRIPTION OF THE INVENTION

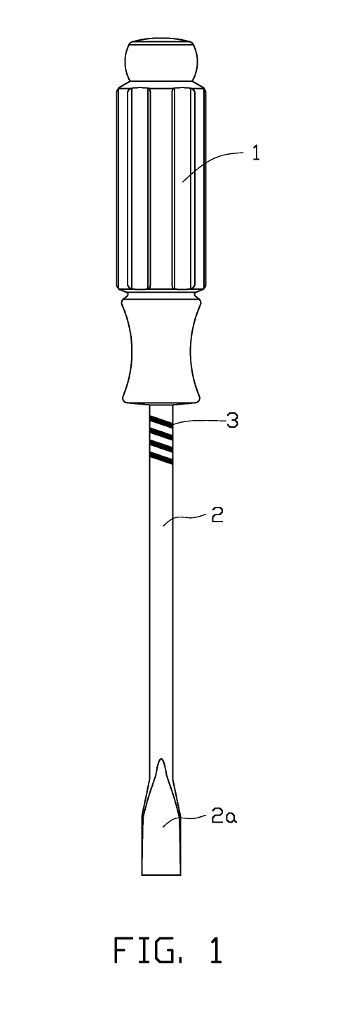

Referring to FIG. 1, a handheld tool such as a screwdriver in accordance with a first preferred embodiment of the present invention includes a handle 1 to be held by a human hand, a shaft 2, a head 2a which is engagable with a fastener such as a screw (not shown), and a diagonal striped portion 3. The shaft 2 extends from an end of the handle 1 terminating at the flathead shaped head 2a. The diagonal striped portion 3 is affixed around or defined in the shaft 2.

In use, when a user rotates the screwdriver around its vertical axis a ‘barberpole illusion’ is created by the diagonal striped portion 3. The diagonal striped portion 3 is arranged so the stripes appear to advance toward the handle 1 when unscrewing or loosening the fastener and advance toward the head 2a when tightening the fastener. A user can take advantage of this effect even before inserting the head 2a into the fastener simply by rotating the screwdriver in their hand and observing the diagonal striped portion 3 and then adjust their grip accordingly and proceed to tighten or loosen the fastener.

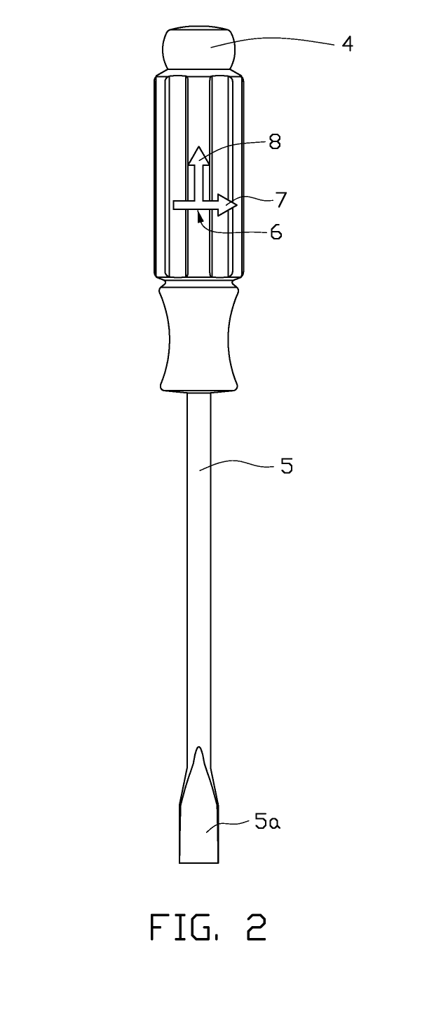

Referring to FIG. 2, a screwdriver in accordance with a second preferred embodiment of the present invention includes a handle 4, a shaft 5, a head 5a, and an indicating sign 6 engraved or affixed on the handle. The indicating sign 6 is engraved on a circle side surface of the handle. The indicating sign 6 includes a horizontal arrowhead 7 and a vertical arrowhead 8. The indicating sign shows that, when a screw is driven according to the direction as the horizontal arrowhead 7 indicates, the screw will be loosened or unscrewed as the vertical arrowhead 8 indicates. In this embodiment, the indicating direction of the horizontal arrowhead 7 and the vertical arrowhead 8 corresponds to a right-hand threaded screw.

it is an advantage that the diagonal striped portion 3 can be set on other handheld tools which rotate about a vertical axis when in use, and the indicating sign 6 may also be used with other tools, such as socket wrenches.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A handheld tool configured to be manually operated to tighten or loosen fasteners, comprising:
a handle configured to be held by a human hand;
a head configured to engage with the fastener in operation;
a shaft extending from an end of the handle and terminating at the head, and
an indicating member arranged on the tool, the indicating member indicating tightening or loosening of the fastener when the tool is operated to rotate the fastener.

2. The handheld tool as claimed in claim 1, wherein the indicating member comprises a diagonal striped portion affixed around or defined in the shaft.

3. The handheld tool as claimed in claim 1, wherein the indicating member comprises an indicating sign, and the indicating sign comprises a horizontal arrowhead and a vertical arrowhead.

4. The handheld tool as claimed in claim 3, wherein the indicating sign is formed on the handle.

5. The handheld tool as claimed in claim 1, wherein the handheld tool is a screwdriver.

6. The handheld tool as claimed in claim 5, wherein the indicating member is designed according to right-hand threaded screw.
